(19) United States
(12) Patent Application Publication
(10) Pub. No.: US 2022/0222542 A1
(43) Pub. Date: Jul. 14, 2022

(54) PARAMETER ESTIMATION DEVICE, PARAMETER ESTIMATION METHOD, AND PARAMETER ESTIMATION PROGRAM

(71) Applicant: NIPPON TELEGRAPH AND TELEPHONE CORPORATION, Tokyo (JP)

(72) Inventors: Noriko YOKOYAMA, Tokyo (JP); Masahiro KOJIMA, Tokyo (JP); Tatsushi MATSUBAYASHI, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/613,042

(22) PCT Filed: May 23, 2019
(86) PCT No.: PCT/JP2019/020540

§ 371 Date: Nov. 20, 2021

(51) Int. Cl. G06N 3/12; G06F 17/11

(52) U.S. Cl. CPC G06N 3/126; G06F 17/11

(57) ABSTRACT

The number of partial functions and a variable for each of the partial functions are determined. Each of partial function optimization execution sections as many as the determined number repeats inputting a predetermined input parameter selected for the variable to a simulator and obtaining the objective function value for one partial function, determines one or more next monitored parameters based on the obtained objective function value, inputs the determined next monitored parameter to the simulator, and obtains the objective function value, and computes an optimal input parameter for the partial function and an objective function optimal value based on the obtained objective function value. Variables of the optimal input parameters of the respective partial functions are combined, each of optimal value candidates related to an input parameter of a whole function is computed, and among the respective computed optimal value candidates, the optimal value candidate that optimizes the objective function value which is based on the objective function optimal value is determined as an optimal input parameter for the whole function.

### TECHNICAL FIELD

The disclosed technique relates to a parameter estimation device, a parameter estimation method and a parameter estimation program.

### BACKGROUND ART

Proliferation of IoT has enabled collection of information on a large number of people and things and there is an active movement towards utilizing collected information in fields of such as tourism, transportation and medicine. Techniques like machine learning and simulation are utilized as data analysis schemes, but search for parameters optimal for them often requires an enormous calculation cost. Thus, as one scheme, for efficient parameter search, Bayesian optimization exists (Non-Patent Literature 1).

Bayesian optimization is a scheme that determines an optimal value (a maximum or a minimum) of a black box function based on a posterior distribution of a function derived from observation information. Bayesian optimization is known to determine an optimal value efficiently compared to random search, which selects parameters randomly, by determining parameters to be monitored on the basis of probability distribution. However, even with Bayesian optimization, there still exists a problem of high calculation cost, especially when parameters are of high dimension or when their possible ranges are large. For example, if a single search takes 7 minutes, 100 attempts will take more than 10 hours.

For example, there is a decomposition scheme assuming an additive structure. The decomposition scheme assuming an additive structure is a scheme which is capable of decomposition into several low-dimension partial functions. The decomposition scheme assuming an additive structure is one scheme for acceleration, which assumes an additive structure of a function and optimizes individual partial functions.

Non-Patent Literature 2, for example, assumes that divided subsets are disjoint and can calculate acquisition functions for partial functions individually. Since division into partial functions results in a lower number of search dimensions, it is expected that an optimal solution can be found with a number of searches that is based on a small number of observation points.

Non-Patent Literature 3 assumes a model that does not require divided subsets to be disjoint, and can adapt to a wider range of situations.

### CITATION LIST

### Non-Patent Literature

Non-Patent Literature 1: J. Snoek, H. Larochelle, R. P. Adams. Practical Bayesian optimization of machine learning algorithms. In Advances in Neural Information Processing Systems (NIPS), 2012.
Non-Patent Literature 2: Kandasamy, K., Schneider, J., Poczos, B.: High Dimensional Bayesian Optimization and Bandits via Additive Models. In: Proceeding s of the 32nd International Conference on Machine Learning (ICML), vol. 37, pp. 295{304 (2015)
Non-Patent Literature 3: Rolland, P., Scarlett, J., Bogunovic, I., and Cevher, V.: High dimensional Bayesian optimization via additive models with over lapping groups. International Conference on Articial Intelligence and Statistics (AISTATS), pp. 298{307 (2018)

### SUMMARY OF THE INVENTION

### Technical Problem

Acceleration of parameter search can be expected by utilizing the findings of the techniques above. However, the decomposition scheme of Non-Patent Literature 2 cannot adapt to a case with an overlap between variables. The scheme of Non-Patent Literature 3 cannot calculate acquisition functions for partial functions by parallel processing and cannot perform efficient search by parallel processing because it requires calculations of the acquisition functions for partial functions to be performed in sequence from a lower layer.

The disclosed technique has been made in light of the foregoing and an object thereof is to provide a parameter estimation device, a parameter estimation method and a parameter estimation program that can determine an optimal input parameter at high speed.

### Means for Solving the Problem

A first aspect of the present disclosure is a parameter estimation device including: a function decomposition unit that determines a number of partial functions and a variable for each of the partial functions; respective partial function optimization execution sections as many as the determined number, the partial function optimization execution sections each configured to: repeat inputting a predetermined input parameter selected for the variable to a predetermined device that outputs an objective function value related to a previously given observed value and obtaining the objective function value for one partial function of the respective partial functions, determine one or more next monitored parameters based on the obtained objective function value, input the determined next monitored parameter to the predetermined device, and obtain the objective function value, and compute an optimal input parameter for the partial function and an objective function optimal value based on the obtained objective function value; and an optimal value determination section that combines variables of the optimal input parameters of the respective partial functions, computes each of optimal value candidates related to an input parameter of a whole function, and determines the optimal value candidate that optimizes the objective function value which is based on the objective function optimal value among the respective computed optimal value candidates as an optimal input parameter for the whole function.

A second aspect of the present disclosure is a parameter estimation method characterized in that a computer executes processing including: determining a number of partial functions and a variable for each of the partial functions; for each of the partial functions as many as the determined number, repeating inputting a predetermined input parameter selected for the variable to a predetermined device that outputs an objective function value related to a previously given observed value and obtaining the objective function value for one partial function of the respective partial functions, determining one or more next monitored parameters based on the obtained objective function value, inputting the determined next monitored parameter to the predetermined device, and obtaining the objective function value, and computing an optimal input parameter for the partial function and an objective function optimal value based on the obtained objective function value; and combining variables of the optimal input parameters of the respective partial functions, computing each of optimal value candidates related to an input parameter of a whole function, and determining the optimal value candidate that optimizes the objective function value which is based on the objective function optimal value among the respective computed optimal value candidates as an optimal input parameter for the whole function.

A third aspect of the present disclosure is a parameter estimation program for causing a computer to: determine a number of partial functions and a variable for each of the partial functions; for each of the partial functions as many as the determined number, repeat inputting a predetermined input parameter selected for the variable to a predetermined device that outputs an objective function value related to a previously given observed value and obtaining the objective function value for one partial function of the respective partial functions, determine one or more next monitored parameters based on the obtained objective function value, input the determined next monitored parameter to the predetermined device, and obtain the objective function value, and compute an optimal input parameter for the partial function and an objective function optimal value based on the obtained objective function value; and combine variables of the optimal input parameters of the respective partial functions, compute each of optimal value candidates related to an input parameter of a whole function, and determine the optimal value candidate that optimizes the objective function value which is based on the objective function optimal value among the respective computed optimal value candidates as an optimal input parameter for the whole function.

### Effects of the Invention

The disclosed technique can determine an optimal input parameter at high speed.

### BRIEF DESCRIPTION OF DRAWINGS

FIG. 1 is a block diagram showing an example of the configuration of a parameter estimation device in this embodiment.

FIG. 2 is a block diagram showing a hardware configuration of the parameter estimation device.

FIG. 3 is a diagram showing an example of a decomposition information DB with data recorded in a database table.

FIG. 4 is a diagram showing an example of a partial function optimization DB with data recorded in a database table.

FIG. 5 is a diagram showing an example of a partial function optimal value DB with data recorded in a database table.

FIG. 6 is a diagram showing an example of an optimization DB with data recorded in a database table.

FIG. 7 is a diagram showing an example of an optimal value DB with data recorded in a database table.

FIG. 8 is a flowchart illustrating parameter estimation processing in the parameter estimation device according to the embodiment of the present disclosure.

FIG. 9 is a flowchart illustrating partial function optimization processing.

FIG. 10 is a flowchart illustrating optimal value determination processing.

### DESCRIPTION OF EMBODIMENTS

An example of the embodiment of the disclosed technique is described below with reference to the drawings. In each drawings, the same or equivalent components and portions are given the same reference numerals. The dimensional scales of the drawings are exaggerated for the sake of description and can be different from the actual scale.

Regarding the object mentioned above, an embodiment of the present disclosure proposes a scheme that assumes a model which does not require decomposed subsets to be disjoint and further can perform optimization of the decomposed subsets by parallel processing in Bayesian optimization using a decomposition scheme.

The embodiment of the present disclosure achieves acceleration of Bayesian optimization by performing optimization for each partial function individually. Further, an optimal value can be uniquely determined by adopting an overall optimal value even when variables of partial functions overlap. Further, decomposition of functions enables parameter search in a high dimension to which Bayesian optimization is difficult to adapt.

Acceleration of Bayesian optimization would enable faster decision making and the like with estimation results in fields like tourism, transportation and medicine.

[Prerequisite]

A prerequisite for the embodiment of the present disclosure is described here. This embodiment is described by taking a problem of estimating an input parameter x for reproducing a pedestrian flow simulation that is close to the actual pedestrian flow based on the number of passers-by y observed at a local place as an example.

For the present problem, input parameters x and f are defined as follows.

x: a D-dimensional vector with the number of agents that pass through each route Rⱼ as elements;

f: a difference between output data yₛᵢₘ of a simulation with x as input and an actually observed value y_{obs}

From the above definition, the present problem can be considered to be an optimization problem of determining x in Expression (1) below. A case with multiple observation points is assumed and a total of an error f(i) at each observation point is summed.

$$\begin{matrix}[ Math . 1 ] & \\ {x}^{*} = {argmin}_{x} f ( x ) & ( 1 )\end{matrix}$$

Then, given a case with two observation points for example, the additive structure of Expression (2) below is assumed:

[Math. 2]

f(x)=f⁽¹⁾(x₁,x₂)+f⁽²⁾(x₂,x₃) (2)

Although this embodiment is described by taking an example of estimating parameters for reproducing a pedestrian flow simulation close to the actual pedestrian flow based on the number of passers-by observed at local places as shown above, it may be used for other data or case where parameter estimation for machine learning or simulation is performed. Further, while this embodiment is described assuming the additive structure of Expression (2) and taking a number of parallelism N=2 for partial functions as an example, the number of parallelism may be set as desired depending on the additive structure of the function. It is assumed that partial functions as many as the number of parallelism exist.

Based on the prerequisite above, configuration and effect of the embodiment of the present disclosure are described in detail below.

<Configuration of Parameter Estimation Device According to an Embodiment of the Present Disclosure>

Next, the configuration of a parameter estimation device according to the embodiment of the present disclosure is described.

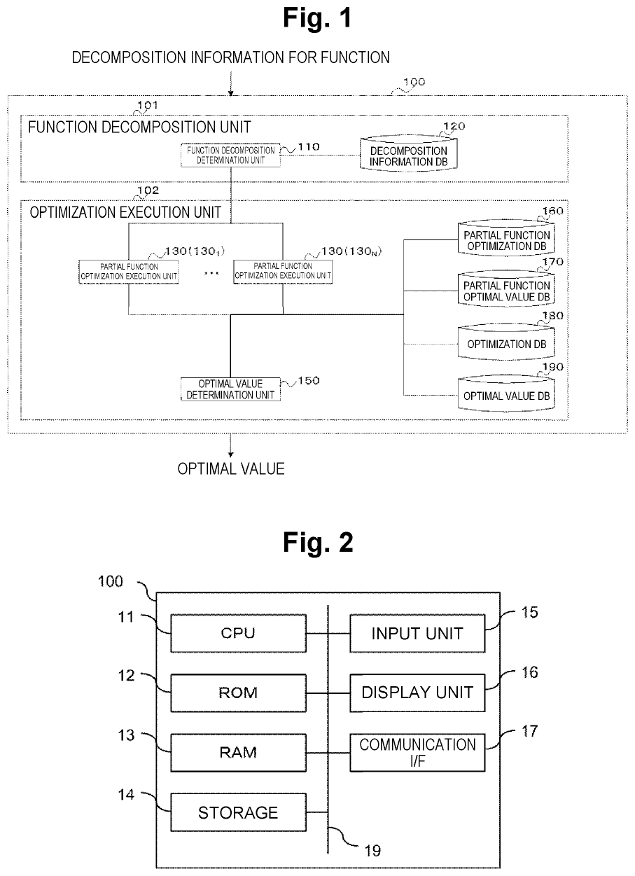

FIG. 1 is a block diagram showing an example of the configuration of a parameter estimation device 100 in this embodiment.

As shown in FIG. 1, the parameter estimation device 100 includes a function decomposition unit 101 and an optimization execution unit 102.

The function decomposition unit 101 includes a function decomposition determination section 110 and a decomposition information DB 120.

The optimization execution unit 102 includes partial function optimization execution sections 130 (130₁-130_{N}), an optimal value determination section 150, a partial function optimization DB 160, a partial function optimal value DB 170, an optimization DB 180 and an optimal value DB 190.

FIG. 2 is a block diagram showing a hardware configuration of the parameter estimation device 100.

As shown in FIG. 2, the parameter estimation device 100 includes a CPU (Central Processing Unit) 11, a ROM (Read Only Memory) 12, a RAM (Random Access Memory) 13, a storage 14, an input unit 15, a display unit 16 and a communication interface (I/F) 17. Each of the components are connected via a bus 19 so as to be able to communicate with each other.

The CPU 11 is a central computation processing unit and executes various programs and controls components. That is, the CPU 11 reads a program from the ROM 12 or the storage 14 and executes the program using the RAM 13 as a work area. The CPU 11 performs control of the components above and various kinds of computation processing in accordance with programs stored in the ROM 12 or the storage 14. In this embodiment, a parameter estimation program is stored in the ROM 12 or the storage 14.

The ROM 12 stores various programs and various data. The RAM 13 temporarily stores a program or data as a work area. The storage 14 consists of an HDD (Hard Disk Drive) or an SSD (Solid State Drive) and stores various programs including an operating system and various data.

The input unit 15 includes a pointing device such as a mouse and a keyboard and is used for performing various kinds of input.

The display unit 16 can be a liquid crystal display, for example, and displays various information. The display unit 16 may also function as the input unit 15 by adopting a touch panel technology.

The communication interface 17 is an interface for communicating with other devices such as terminals and a standard such as Ethernet (a registered trademark), FDDI, and Wi-Fi (a registered trademark) is used, for example.

Next, the functional components of the parameter estimation device 100 are each described. Each of the functional components are implemented by the CPU 11 reading the parameter estimation program stored in the ROM 12 or the storage 14 and loading and executing it in the RAM 13.

The function decomposition unit 101 receives decomposition information for a function and determines the number of partial functions and a variable for each of the partial functions. The number of partial functions is N, and N (1, . . . , N) represents a partial function number in the following. In this embodiment, N=2. The determined number of partial functions and variables are recorded in the decomposition information DB 120. The variables are variables that affect the partial functions. Decomposition information is received through input from a user, but automatically determined decomposition information may be used without receiving one from the user. The optimization scheme described below illustrates an example that uses Bayesian optimization.

The optimization execution unit 102 creates each of partial function optimization execution sections 130 (130₁-130_{N}) as many as the determined number of partial functions and executes processing by each partial function optimization execution section 130 in parallel. As respective processing performed by each partial function optimization execution section 130 is similar to one another, processing by one partial function optimization execution section 130 will be described below.

The partial function optimization execution section 130 repeats inputting an input parameter x selected for the variable to a simulator and obtaining an objective function value for one partial function of the respective partial functions. The simulator may be any predetermined device that supports the optimization scheme and a predetermined device that outputs an objective function value related to a previously given observed value is used. Next, the partial function optimization execution section 130 determines one or more next monitored parameters x^{next} based on the obtained objective function values, inputs the determined next monitored parameter(s) x^{next} to the simulator and acquires an objective function value. The next monitored parameter x^{next} is determined by approximating a function representing a relationship between the input parameter x and the objective function value with a probabilistic model, e.g., Gaussian process, and using the approximated function and an acquisition function a which uses the input parameter x that optimizes the objective function value. Then, the partial function optimization execution section 130 computes optimal input parameters for the partial function and an objective function optimal value based on the objective function values resulting from the respective processing above.

The optimal value determination section 150 combines the variables of the respective optimal input parameters of the partial functions and computes each of optimal value candidates for the whole function. The optimal value determination section 150 determines an optimal input parameter for the whole function according to the optimal value candidate that optimizes an objective function value which is based on the objective function optimal value among the respective optimal value candidates computed. The optimal value determination section 150 also repeats a predetermined number of times acquisition of objective function values with the next monitored parameter x^{next} by the partial function optimization execution sections 130, computation of the optimal input parameters for the partial functions and the objective function optimal value, and the above-described processing by the optimal value determination section 150.

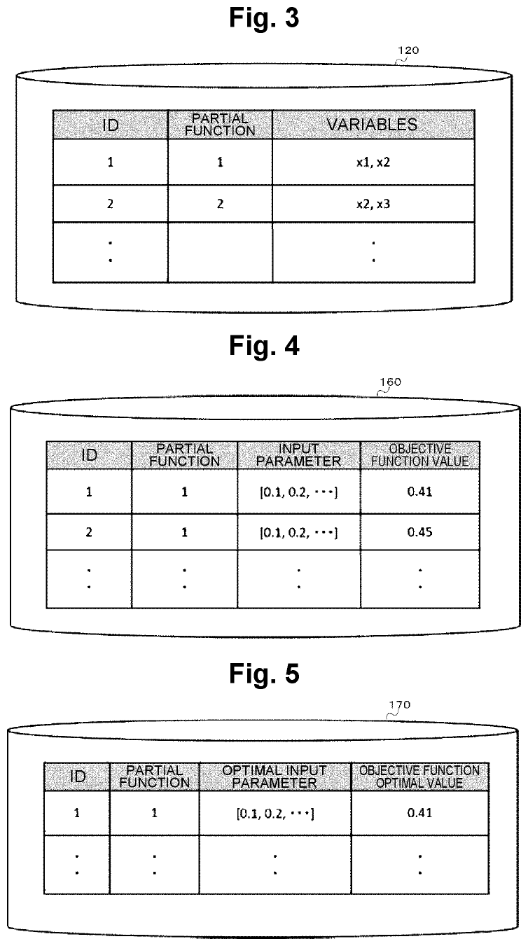

The decomposition information DB 120 is a database for recording IDs, partial function numbers and variables. FIG. 3 is a diagram showing an example of the decomposition information DB 120 with data recorded in a database table.

The partial function optimization DB 160 is a database for recording IDs, partial function numbers, input parameters of the partial functions, and objective function values acquired for the corresponding partial functions and the corresponding input parameters. FIG. 4 is a diagram showing an example of the partial function optimization DB 160 with data recorded in a database table. For the input parameter of the partial function, the variables of the input parameter are recorded. For the objective function value, a value acquired for the corresponding input parameter by the partial function optimization execution section 130 is recorded.

The partial function optimal value DB 170 is a database for recording IDs, partial function numbers, optimal input parameters of the partial functions, and objective function optimal values acquired for the corresponding optimal input parameters. FIG. 5 is a diagram showing an example of the partial function optimal value DB 170 with data recorded in a database table. For the optimal input parameter of the partial function and the objective function optimal value, values computed by the partial function optimization execution section 130 are recorded. Since values as many as the number N of partial functions are recoded in the partial function optimal value DB 170, the number of records agrees with the number N of partial functions. For the optimal input parameter of each partial function, the variables of the optimal input parameter are recorded. For the objective function optimal value, a value acquired for the corresponding optimal input parameter by the partial function optimization execution section 130 is recorded.

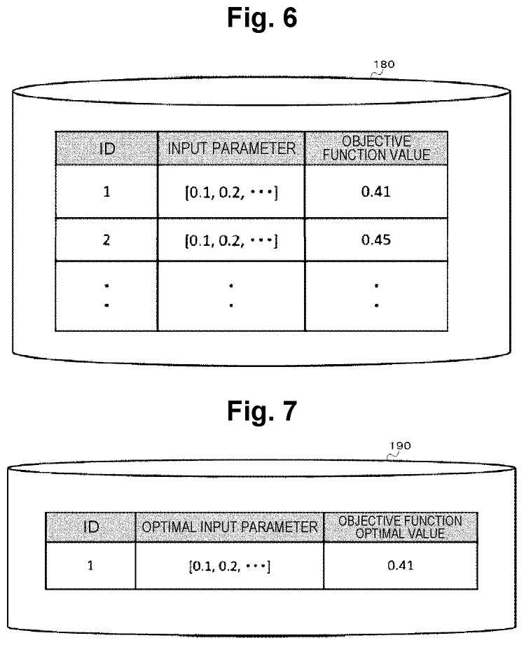

The optimization DB 180 is a database for recording IDs, input parameters and objective function values. FIG. 6 is a diagram showing an example of the optimization DB 180 with data recorded in a database table. For the input parameter, the variables of the input parameters of optimal value candidates are recorded. For the objective function value, values acquired for the optimal value candidates are recorded.

The optimal value DB 190 is a database for recording an ID, the optimal input parameter of the whole function, and the objective function optimal value acquired for the corresponding optimal input parameter. FIG. 7 is a diagram showing an example of the optimal value DB 190 with data recorded in a database table. For the optimal input parameter, the variables of the input parameter of the optimal value from the optimal value candidates are recorded. For the objective function value, the value of the optimal value of the optimal value candidate is recorded.

<Action of the Parameter Estimation Device According to the Embodiment of the Present Disclosure>

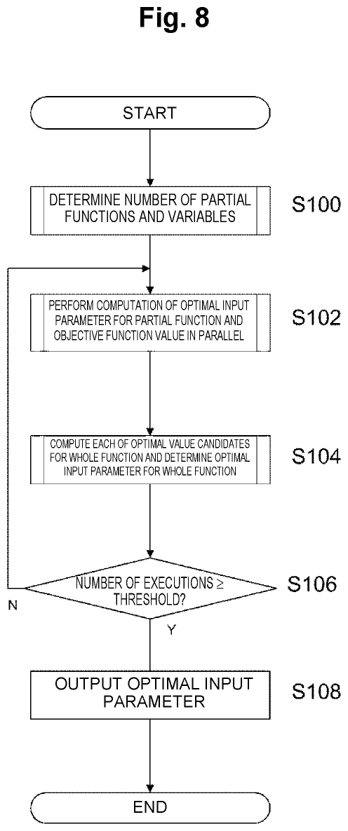

Next, the action of the parameter estimation device 100 according to the embodiment of the present disclosure is described. FIG. 8 is a flowchart illustrating parameter estimation processing in the parameter estimation device 100 according to the embodiment of the present disclosure. The parameter estimation processing is performed by reading of the parameter estimation program from the ROM 12 or the storage 14 and loading and executing it in the RAM 13 by the CPU 11. The parameter estimation device 100 receives decomposition information for a function as input and performs the following process.

In S100, the CPU 11 receives decomposition information for a function and determines the number of partial functions and a variable for each of the partial functions.

In S5102, the CPU 11 repeats as the partial function optimization execution section 130 inputting parameter x selected for the variable to a simulator and obtaining the objective function value for one partial function of the respective partial functions. One or more next monitored parameters x^{next} are determined based on the obtained objective function values, the determined next monitored parameter(s) x^{next} are input to the simulator, and an objective function value is acquired. Optimal input parameters for the partial functions and an objective function optimal value are computed based on the objective function values resulting from the respective processing above. The process of computing the optimal input parameter and the objective function optimal value is executed in parallel as described above.

In S104, the CPU 11 as the optimal value determination section 150 combines the variables of the respective optimal input parameters of the partial functions and computes each of optimal value candidates for the whole function. An optimal input parameter for the whole function is determined according to the optimal value candidate that optimizes an objective function value which is based on the objective function optimal value among the respective optimal value candidates computed.

In S106, the CPU 11 as the optimal value determination section 150 determines whether the number of executions of S102 and S104 by the optimization execution unit 102 is equal to or greater than a threshold. If it is equal to or greater than the threshold, the flow proceeds to S108, and if it is less than the threshold, the flow returns to S102, where processing is repeated. While the processing at S102 differs depending on whether the number of times optimization has been performed is one or not, its details are discussed later. This causes the acquisition of objective function values with the next monitored parameter x^{next} and computation of the optimal input parameters of the partial functions and the objective function optimal value at S102 as well as the processing at S104 to be repeated a predetermined number of times.

In S108, the optimal input parameter in the optimal value DB 190 is output and the processing is finished. Specifically, the record of the optimal value DB 190 is retrieved and (1, x*, f⁽¹⁾ (x*)), including an optimal input parameter x*, is output as optimal parameter information.

In the following, details of the processing in S102 and S104 discussed above are described.

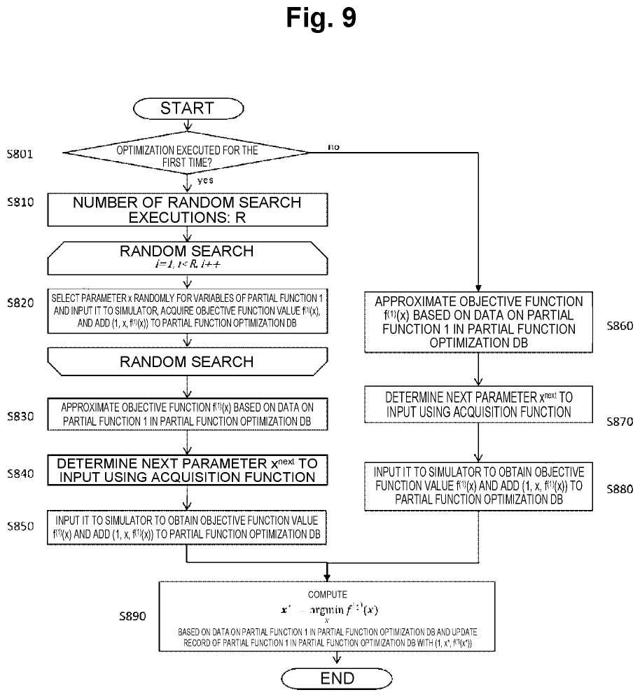

FIG. 9 is a flowchart illustrating the partial function optimization processing in S102. The partial function optimization processing is executed by the CPU 11 as the partial function optimization execution section 130. The following is described by taking a case of executing it for a partial function 1 with a partial function number 1 as an example.

In S801, the CPU 11 determines whether the number of times partial function optimization processing has been executed by the partial function optimization execution section 130 is one or not, and proceeds to S810 if it is one and to S860 if it is two or more.

In S810, the CPU 11 sets a number of random search executions to R. The value of R may be used a value previously saved in a DB such as the partial function optimization DB 160 or a value received through an input from the user.

The processing step of S820 described below is repeatedly executed R times.

In S820, the CPU 11 randomly selects the parameter x for the variable of the partial function 1 in the decomposition information DB 120 and inputs it to the simulator to obtain an objective function value f⁽¹⁾ (x). Then, (1, x, f⁽¹⁾ (x)) is added to the records of the partial function optimization DB 160.

In S830, the CPU 11 approximates a function f representing a relationship between the input parameter x and the objective function value f⁽¹⁾ (x) with the Gaussian process based on data on the partial function 1 in the partial function optimization DB 160.

Given that the function f conforms to the Gaussian process here, an arbitrary subset will conform to the Gaussian distribution:

P(f)=N (f|0, Kₙₙ)

Here, Kₙₙ is a n×n variance-covariance matrix and its (d, d′) element k_{d d′} is represented by k (x_{d}, x′_{d}) using a kernel function k (⋅, ⋅). Then, a posterior probability of output variable y* of an unknown input variable x given y=f(x) is given by the Gaussian distribution of Expression (3):

[Math. 3]

f(x)=f⁽¹⁾(x₁,x₂)+f⁽²⁾(x₂,x₃) (3)

Here, Cₙₙ=Kₙₙ+σ²Iₙ is defined, where Iₙ represents an n×n unit matrix. Accordingly, prediction is possible with Expression (3).

In S840, the CPU 11 determines the next monitored parameter x^{next} that is likely to satisfy Expression (5) according to Expression (4) below. At this point, multiple x^{next} may be chosen in descending order of likeliness rather than one.

$$\begin{matrix}[ Math . 4 ] & \\ {x}^{next} = {argmin}_{x} α ( x ) & ( 4 ) \\ {x}^{*} = {argmin}_{x} {f}^{( 1 )} ( x ) & ( 5 )\end{matrix}$$

Here, α is called an acquisition function, for which several functions have been proposed (Non-Patent Literature 1). For example, when EI (Expected Improvement) is used, the acquisition function can be calculated by (6):

[Math. 5]

f(x)=f⁽¹⁾(x₁,x₂)+f⁽²⁾(x₂,x₃) (6)

Here, μ is an average, σ is standard deviation, and Φ and ϕ are CDF and PDF of standard normal distribution, respectively, and they are derived using the function f that was approximated with the Gaussian process in S630. τ is an optimal parameter x_{best} in past, for which the optimal input parameter from the partial function optimal value DB 170 for the corresponding partial function 1 is used when the repeated processing by the optimization execution unit 102 is performed for the first time. When it is performed for the second and subsequent times, the optimal input parameter from the optimal value DB 190 is used.

In S850, the CPU 11 inputs the input parameter x to the simulator as x=x^{next} and obtains the objective function value f⁽¹⁾ (x). Then, (1, x, f⁽¹⁾ (x)) is added to the partial function optimization DB 160.

The foregoing is processing in the first time of the partial function optimization processing. The following S860 to S890 are processing in the second and subsequent times.

In S860, the CPU 11 approximates the objective function f⁽¹⁾ (x) with the Gaussian process based on data on the partial function 1 in the partial function optimization DB 160. It is similar to S830.

In S870, the CPU 11 determines the next monitored parameter x^{next} that is likely to satisfy Expression (5) above using an acquisition function. At this point, multiple x^{next} may be chosen in descending order of likeliness rather than one. Further, in calculation of the acquisition function, information on the optimal input parameter is taken from the optimal value DB 190 and means such as modifying the acquisition function or limiting a search range is used so that search is more likely to be performed in neighborhood of the optimal value. Possible methods of modifying the acquisition function include one that adds a Gaussian distribution with an optimal input parameter x_{fbest} being the mean to the acquisition function, as in Expression (7):

[Math. 6]

α(x)=α(x)+AN(x_{fbest},s²) (7)

For limiting the search range, a method that limits the function to the neighborhood of the optimal input parameter x_{fbest} and the like may be used. Moreover, rather than adding modification or limitation to the acquisition function, modification or limitation may be added at the stage of function approximation in S860. In this manner, the partial function optimization execution section 130 determines the next monitored parameter so as to place priority on the neighborhood of the optimal input parameter for the whole function that has been determined in the immediately preceding processing in repetition by the optimal value determination section 150.

In S880, the CPU 11 inputs the input parameter x to the simulator as x=x^{next} and acquires the objective function value f⁽¹⁾ (x). Then, (1, x, f⁽¹⁾ (x)) is added to the partial function optimization DB 160.

In S890, the CPU 11 computes an optimal input parameter x* for the partial function 1 according to Expression (8) below based on data on the partial function 1 from the partial function optimization DB 160 and updates the record of the partial function 1 in the partial function optimal value DB 170 with (1, x*, f⁽¹⁾ (x*)).

$$\begin{matrix}[ Math . 7 ] & \\ {x}^{*} = {argmin}_{x} {f}^{( 1 )} ( x ) & ( 8 )\end{matrix}$$

While in this embodiment S830 to S850 or S860 to S880 are performed for only one cycle, they may be performed for multiple cycles, after which the flow may proceed to S890.

The foregoing is the description on the partial function optimization processing in S102.

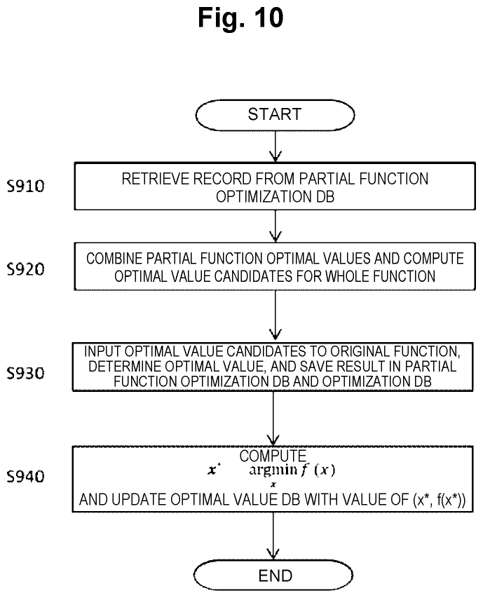

FIG. 10 is a flowchart illustrating the optimal value determination processing in S104. The optimal value determination processing is executed by the CPU 11 as the optimal value determination section 150.

In S910, the CPU 11 retrieves the respective records of the partial functions from the partial function optimal value DB 170.

In S920, the CPU 11 combines the optimal values of the respective variables acquired and computes optimal value candidate D=f {xᵢ|i=1, . . . , C} for the whole function. Here, C is the number of combinations of partial functions and is represented by xᵢ=(x₁ᵢ, x₂ᵢ, x₃ᵢ), for example. For computation of optimal value candidates, various methods are conceivable aside from combination, such as taking an average of optimal values if the optimal value candidates of the respective variables conflict with each other.

In S930, the CPU 11 inputs the optimal value candidates to a simulator that determines the original function, determines the optimal value, and saves the result in the optimization DB 180. The objective function values of the partial functions are also saved in the partial function optimization DB 160. In S940, the optimal input parameter x* for the whole function is computed by Expression (9) below and the optimal value DB 190 is updated with the value of (1, x*, f(x*)).

$$\begin{matrix}[ Math . 8 ] & \\ {x}^{*} = {argmin}_{x ∈ D} f ( x ) & ( 9 )\end{matrix}$$

Subsequently, the flow proceeds to step 106.

The foregoing is the description on the optimal value determination processing in S104.

As has been described above, the parameter estimation device 100 in this embodiment executes processing for computing the optimal input parameter and the objective function optimal value for each partial function in parallel. Optimal value candidates are computed for the whole function from the results of computation and the optimal input parameter and the objective function optimal value for the whole function are computed. This can accelerate Bayesian optimization.

It is noted that the present disclosure is not limited to the above-described embodiment and various modifications and applications are possible without departing from the spirit of the invention.

For example, the present scheme is also applicable to black box optimization schemes other than Bayesian optimization. For example, adaptation to genetic algorithm (GA) and evolution strategy (ES) is conceivable.

While the embodiment above was described by taking the case of using approximation with the Gaussian process in Bayesian optimization as an example, an approximation scheme with a different probabilistic model such as random forest may be used.

While the embodiment above was described by taking the case of inputting the input parameter to a simulator and obtaining an objective function value in application to Bayesian optimization and the simulator being a predetermined device as an example, the input parameter may be input to a predetermined device that supports each optimization scheme of interest and an objective function value may be obtained.

Multi-task learning that is executed by reading of software (program) by a CPU in the above embodiment may be executed by any of various processors other than a CPU. Examples of processors in such a case include a PLD (Programmable Logic Device) which allows change of circuit configuration after manufacture such as FPGA (Field-Programmable Gate Array), and a dedicated electric circuit as a processor having a circuit configuration specifically designed for execution of specific processing such as ASIC (Application Specific Integrated Circuit). The multi-task learning may also be executed by one of these various processors or a combination of two or more processors of the same type or different types (e.g., multiple FPGAs and combination of a CPU and a FPGA). Hardware structures of these various processors are more specifically electric circuits that combine circuit elements such as semiconductor elements.

Additionally, while the embodiment above showed an aspect where a multi-task learning program is prestored (installed) in the storage 14, the present disclosure is not limited thereto. The program may be provided in a form of being stored in a non-transitory storage medium such as CD-ROM (Compact Disk Read Only Memory), DVD-ROM (Digital Versatile Disk Read Only Memory), and USB (Universal Serial Bus) memory. The program may also be in a form of being downloaded from an external device over a network.

In connection with the foregoing embodiment, appendices are further disclosed below.

### APPENDIX ITEM 1

A parameter estimation device including:

a memory; and

at least one processor connected with the memory, the processor is configured to:

determine the number of partial functions and a variable for each of the partial functions;

for each of the partial functions as many as the determined number,
repeat inputting a predetermined input parameter selected for the variable to a predetermined device that outputs an objective function value related to a previously given observed value and obtaining the objective function value for one partial function of the respective partial functions,
determine one or more next monitored parameters based on the obtained objective function value, input the determined next monitored parameter to the predetermined device, and obtain the objective function value, and
compute an optimal input parameter for the partial function and an objective function optimal value based on the obtained objective function value; and

combine variables of the optimal input parameters of the respective partial functions, compute each of optimal value candidates related to an input parameter of a whole function, and determine the optimal value candidate that optimizes the objective function value which is based on the objective function optimal value among the respective computed optimal value candidates as an optimal input parameter for the whole function.

### APPENDIX ITEM 2

A non-transitory storage medium storing a parameter estimation program for causing a computer to:

determine the number of partial functions and a variable for each of the partial functions;

for each of the partial functions as many as the determined number,
repeat inputting a predetermined input parameter selected for the variable to a predetermined device that outputs an objective function value related to a previously given observed value and obtaining the objective function value for one partial function of the respective partial functions,
determine one or more next monitored parameters based on the obtained objective function value, input the determined next monitored parameter to the predetermined device, and obtain the objective function value, and
compute an optimal input parameter for the partial function and an objective function optimal value based on the obtained objective function value; and

combine variables of the optimal input parameters of the respective partial functions, compute each of optimal value candidates related to an input parameter of a whole function, and determine the optimal value candidate that optimizes the objective function value which is based on the objective function optimal value among the respective computed optimal value candidates as an optimal input parameter for the whole function.

### REFERENCE SIGNS LIST

100 parameter estimation device
101 function decomposition unit
102 optimization execution unit
110 function decomposition determination section
130 partial function optimization execution section
150 optimal value determination section
120 decomposition information DB
160 partial function optimization DB
170 partial function optimal value DB
180 optimization DB
190 optimal value DB

1. A parameter estimation device comprising:
a function decomposition unit that determines a number of partial functions and a variable for each of the partial functions;
respective partial function optimization execution sections as many as the determined number, the partial function optimization execution sections each configured to:
repeat inputting a predetermined input parameter selected for the variable to a predetermined device that outputs an objective function value related to a previously given observed value and obtaining the objective function value for one partial function of the respective partial functions,
determine one or more next monitored parameters based on the obtained objective function value, input the determined next monitored parameter to the predetermined device, and obtain the objective function value, and
compute an optimal input parameter for the partial function and an objective function optimal value based on the obtained objective function value; and
an optimal value determination section that combines variables of the optimal input parameters of the respective partial functions, computes each of optimal value candidates related to an input parameter of a whole function, and determines the optimal value candidate that optimizes the objective function value which is based on the objective function optimal value among the respective computed optimal value candidates as an optimal input parameter for the whole function.

2. The parameter estimation device according to claim 1, wherein a function representing a relationship between the predetermined input parameter and the objective function value is approximated with a probabilistic model, and a next monitored parameter is determined using the approximated function and an acquisition function which uses the predetermined input parameter that optimizes the objective function value.

3. The parameter estimation device according to claim 1, wherein the optimal value determination section repeats, a predetermined number of times, acquisition of objective function values with the next monitored parameter by the partial function optimization execution sections, computation of the optimal input parameters for the partial functions and the objective function optimal value, and processing by the optimal value determination section.

4. The parameter estimation device according to claim 3, wherein in the repetition, the partial function optimization execution sections each determines the next monitored parameter so as to place priority on neighborhood of an optimal input parameter for the whole function that has been determined in immediately preceding processing in repetition by the optimal value determination section.

5. A parameter estimation method characterized in that a computer executes processing comprising:
determining a number of partial functions and a variable for each of the partial functions;
for each of the partial functions as many as the determined number,
repeating inputting a predetermined input parameter selected for the variable to a predetermined device that outputs an objective function value related to a previously given observed value and obtaining the objective function value for one partial function of the respective partial functions,
determining one or more next monitored parameters based on the obtained objective function value, inputting the determined next monitored parameter to the predetermined device, and obtaining the objective function value, and
computing an optimal input parameter for the partial function and an objective function optimal value based on the obtained objective function value; and
combining variables of the optimal input parameters of the respective partial functions, computing each of optimal value candidates related to an input parameter of a whole function, and determining the optimal value candidate that optimizes the objective function value which is based on the objective function optimal value among the respective computed optimal value candidates as an optimal input parameter for the whole function.

6. The parameter estimation method according to claim 5, wherein a function representing a relationship between the predetermined input parameter and the objective function value is approximated with a probabilistic model, and a next monitored parameter is determined using the approximated function and an acquisition function which uses the predetermined input parameter that optimizes the objective function value.

7. The parameter estimation method according to claim 5, wherein acquisition of objective function values with the next monitored parameter, computation of the optimal input parameters for the partial functions and the objective function optimal value, and processing for determining an optimal input parameter for the whole function are repeated a predetermined number of times.

8. A parameter estimation program for causing a computer to:
determine a number of partial functions and a variable for each of the partial functions;
for each of the partial functions as many as the determined number,
repeat inputting a predetermined input parameter selected for the variable to a predetermined device that outputs an objective function value related to a previously given observed value and obtaining the objective function value for one partial function of the respective partial functions,
determine one or more next monitored parameters based on the obtained objective function value, input the determined next monitored parameter to the predetermined device, and obtain the objective function value, and
compute an optimal input parameter for the partial function and an objective function optimal value based on the obtained objective function value; and
combine variables of the optimal input parameters of the respective partial functions, compute each of optimal value candidates related to an input parameter of a whole function, and determine the optimal value candidate that optimizes the objective function value which is based on the objective function optimal value among the respective computed optimal value candidates as an optimal input parameter for the whole function.

9. The parameter estimation device according to claim 2, wherein the optimal value determination section repeats, a predetermined number of times, acquisition of objective function values with the next monitored parameter by the partial function optimization execution sections, computation of the optimal input parameters for the partial functions and the objective function optimal value, and processing by the optimal value determination section.

10. The parameter estimation device according to claim 9, wherein in the repetition, the partial function optimization execution sections each determines the next monitored parameter so as to place priority on neighborhood of an optimal input parameter for the whole function that has been determined in immediately preceding processing in repetition by the optimal value determination section.

11. The parameter estimation method according to claim 6, wherein acquisition of objective function values with the next monitored parameter, computation of the optimal input parameters for the partial functions and the objective function optimal value, and processing for determining an optimal input parameter for the whole function are repeated a predetermined number of times.
